(19) United States
(12) Patent Application Publication
(10) Pub. No.: US 2012/0081651 A1
(43) Pub. Date: Apr. 5, 2012

(54) DISPLAY PANEL

(75) Inventor: Katsunori Misaki, Yonago-shi (JP)

(73) Assignee: Sharp Kabushiki Kaisha, Osaka-shi, Osaka (JP)

(21) Appl. No.: 13/376,547

(22) PCT Filed: Mar. 31, 2010
(86) PCT No.: PCT/JP2010/002380

§ 371 Date: Dec. 6, 2011

(30) Foreign Application Priority Data
Jul. 9, 2009 (JP) 2009-162397

(51) Int. Cl. G02F 1/1339

(52) U.S. Cl. 349/153

(57) ABSTRACT

In a picture-frame region (F) of a liquid crystal display panel (1), a wall member (41) is provided, which is formed adjacent to a sealing material (40) and sandwiches the sealing material (40). Steps (42a), (43a) are formed in the wall member (41) so that a width (W1) of a portion (40a) of the sealing material (40), which contacts a TFT substrate (2) is larger on a side on which the sealing material (40) contacts the TFT substrate (2).

### REFERENCE TO RELATED APPLICATIONS

This application is a national stage application under 35 USC 371 of international Application No. PCT/JP2010/002380, filed Mar. 31, 2010, which claims the priority of Japanese Application No. JP2009-162397, filed Jul. 9, 2009, the contents of which prior applications are incorporated here by reference.

### FIELD OF THE INVENTION

The present invention relates to a display panel such as a liquid crystal display panel in which a pair of substrates are stacked with a predetermined clearance and liquid crystal is sealed in the clearance between the pair of substrates.

### BACKGROUND OF THE INVENTION

Since a liquid crystal display panel which is one of display panels is thin and light-weight, the liquid crystal display panel has been broadly used for mobile devices such as laptop computers and mobile phones and audio-visual equipment such as liquid crystal televisions.

Typically, a liquid crystal display panel includes a pair of substrates (i.e., a thin film transistor (TFT) substrate and a color filter (CF) substrate) arranged so as to face each other, and a liquid crystal layer provided between the pair of substrates. In addition, the liquid crystal display panel further includes a frame-shaped sealing material for bonding the pair of substrates together and sealing liquid crystal between both of the substrates, and a plurality of spacers for regulating the thickness of the crystal layer.

The liquid crystal display panel of this type is used for mobile devices such as mobile phones, mobile terminal devices, and portable game devices. Considering portability, miniaturization, and thickness reduction, expansion of a pixel region in the liquid crystal display panel has been strongly required for the mobile devices. In order to realize the expansion of the pixel region in the liquid crystal display panel, it is necessary that a portion (i.e., a picture-frame region) of a liquid crystal panel outside a display region is narrowed as much as possible. That is, narrowing of the picture-frame region in the liquid crystal display panel is required.

However, in order to realize the narrowing of the picture-frame region, it is necessary that the width of the sealing material to be provided in the picture-frame region is reduced. In order to reduce the width of the sealing material, it is necessary that an amount of the sealing material to be discharged when the sealing material is applied is reduced. However, the reduction in amount of the sealing material to be discharged may cause discontinuous application of the sealing material.

Thus, in the liquid crystal display panel for which progress in narrowing the picture-frame region is made, it is difficult to form a sealing portion in a predetermined position of the substrate with good accuracy. In addition, a problem is caused, in which, when the discontinuous application of the sealing material is caused, an impurity enters the liquid crystal display panel through the sealing material, and, as a result, contamination of liquid crystal due to the entering of the impurity causes display defects such as display unevenness.

A liquid crystal display panel has been proposed, in which entering of an impurity through a sealing material is prevented while reducing a sealing material width.

More specifically, a liquid crystal display panel is disclosed, in which a pair of transparent substrates are bonded together by a sealing material provided in a picture-frame region around a display region and liquid crystal is sealed in a portion surrounded by the sealing material between the substrates. In the liquid crystal display panel, a linear spacer wall made of a material having better erosion resistance than that of the sealing material is formed on an inner side relative to the sealing material. According to such a configuration, entering of an impurity through the sealing material can be prevented while reducing a sealing material width, and therefore narrowing of the picture-frame region can be realized (see, e.g., Patent Document 1).

### PATENT DOCUMENT

PATENT DOCUMENT 1: Japanese Patent Publication No. 2002-040442

### SUMMARY OF THE INVENTION

However, in the liquid crystal display panel described in Patent Document 1, the configuration is employed, in which the spacer wall is formed on the inner side relative to the sealing material in the picture-frame region. Thus, an area where the sealing material and the substrate contact each other is reduced. As a result, a problem is caused, in which adhesion between the sealing material and the substrate is reduced, thereby peeling off the sealing material.

The present invention has been made in view of the foregoing, and it is an objective of the present invention to provide a display panel in which reduction in adhesion between a sealing material and a substrate is prevented and narrowing of a picture-frame region can be realized by a suitable amount of the sealing material.

In order to achieve the foregoing objective, a display panel of the present invention includes a first substrate; a second substrate arranged so as to face the first substrate; a display medium layer provided between the first and second substrates; and a sealing material for bonding the first and second substrates together, which is provided in a picture-frame region defined around a display region where an image is displayed and is sandwiched between the first and second substrates. A wall member formed adjacent to the sealing material and sandwiching the sealing material is provided in the picture-frame region, and a step is formed in the wall member so that a width of a portion of the sealing material, which contacts at least one of the first or second substrate is larger on a side on which the sealing material contacts the at least one of the first or second substrate.

According to the foregoing configuration, since the width of the portion which contacts the at least one of the first or second substrate is larger in the sealing material, an area where the sealing material and the at least one of the first or second substrate contacting the sealing material can be increased. As a result, even if the width of the sealing material to be provided in the picture-frame region is reduced in order to realize narrowing of the picture-frame region, adhesion between the sealing material and the at least one of the first or second substrate is improved, thereby preventing a disadvantage that the sealing material is peeled off.

In addition, since the width of a portion other than the portion contacting the at least one of the first or second substrate is smaller in the sealing material, an amount of the sealing material to be used can be reduced. Thus, an increase in cost can be reduced, and, as a result, the narrowing of the picture-frame region can be realized by a suitable amount of the sealing material.

In the display panel of the present invention, the second substrate may include a colored layer, a black matrix, and a spacer for regulating a thickness of the display medium layer on a liquid crystal layer side and further include a rib protruding from the second substrate toward the first substrate in the liquid crystal layer, and the wall member may be made of a material forming at least one selected from a group consisting of the colored layer, the black matrix, the spacer, and the rib.

According to the foregoing configuration, the wall member can be made of an inexpensive general-purpose material which is already used for the second substrate without using other materials.

In the display panel of the present invention, the second substrate may include a colored layer on a liquid crystal layer side, and the wall member may be made of a material forming the colored layer.

According to the foregoing configuration, the wall member can be made of an inexpensive general-purpose material forming the colored layer without using other materials.

In the display panel of the present invention, the second substrate may further include a rib protruding from the second substrate toward the first substrate in the liquid crystal layer, and the wall member may be formed by stacking the material forming the colored layer and a material forming the rib.

According to the foregoing configuration, the wall member can be made of inexpensive general-purpose materials forming the colored layer and the rib without using other materials.

In the display panel of the present invention, the second substrate may further include a black matrix on the liquid crystal layer side, and the wall member may be formed by stacking the material forming the colored layer, the material forming the rib, and a material forming the black matrix.

According to the foregoing configuration, the wall member can be made of inexpensive general-purpose materials forming the colored layer, the rib, and the black matrix without using other materials.

In the display panel of the present invention, the second substrate may include a black matrix and a spacer for regulating a thickness of the display medium layer on a liquid crystal layer side, and the wall member may be formed by stacking a material forming the black matrix and a material forming the spacer.

Thus, the wall member can be made of inexpensive general-purpose materials forming the black matrix and the spacer without using other materials.

In the display panel of the present invention, the sealing material may be mixed with glass fibers.

According to the foregoing configuration, the glass fibers allow a weight on the sealing material in the first side direction of the display panel and a weight on the sealing material in the second side direction of the display panel to be equal to each other. Thus, since holding of the first and second substrates with a predetermined clearance can be ensured, setting of the thickness of the display medium layer in the first side direction of the display panel and the thickness of the display medium layer in the second side direction of the display panel to the same value can be ensured. As a result, a uniform thickness of the display medium layer can be maintained.

In addition, the display panel of the present invention has excellent properties which prevents the disadvantage that the sealing material is peeled off, and which reduces the increase in cost to realize the narrowing of the picture-frame region by the suitable amount of the sealing material. Thus, the display panel of the pre sent invention is suitable for a display panel using a liquid crystal layer as the display medium layer.

According to the present invention, the disadvantage that the sealing material is peeled off can be prevented, and t he increase in cost can be reduced to realize the narrowing of the picture-frame region by the suitable amount of the sealing material.

### BRIEF DESCRIPTION OF THE DRAWINGS

FIG. 1 is a plan view illustrating an entire configuration of a liquid crystal display panel of a first embodiment of the present invention.

FIG. 2 is a cross-sectional view of the liquid crystal display panel of the first embodiment of the present invention.

FIG. 3 is an equivalent circuit diagram of the liquid crystal display panel of the first embodiment of the present invention.

FIG. 4 is a cross-sectional view illustrating an entire configuration of a TFT substrate forming the liquid crystal display panel of the first embodiment of the present invention.

FIG. 5 is a cross-sectional view illustrating an entire configuration of a display section of the liquid crystal display panel of the first embodiment of the present invention.

FIG. 6 is a cross-sectional view of the liquid crystal display panel of the first embodiment of the present invention in a side direction thereof, i.e., a cross-sectional view of FIG. 1 along an A-A line.

FIG. 7 is a cross-sectional view illustrating a configuration of a wall member in the liquid crystal display panel of the first embodiment of the present invention.

FIG. 8 is a cross-sectional view illustrating a step of a liquid crystal display panel manufacturing method of the first embodiment of the present invention.

FIG. 9 is a cross-sectional view illustrating another step of the liquid crystal display panel manufacturing method of the first embodiment of the present invention.

FIG. 10 is a cross-sectional view illustrating still another step of the liquid crystal display panel manufacturing method of the first embodiment of the present invention.

FIG. 11 is a cross-sectional view illustrating still another step of the liquid crystal display panel manufacturing method of the first embodiment of the present invention.

FIG. 12 is a cross-sectional view illustrating still another step of the liquid crystal display panel manufacturing method of the first embodiment of the present invention.

FIG. 13 is a cross-sectional view illustrating still another step of the liquid crystal display panel manufacturing method of the first embodiment of the present invention.

FIG. 14 is a cross-sectional view of a liquid crystal display panel of a second embodiment of the present invention in a side direction thereof.

FIG. 15 is a cross-sectional view illustrating a configuration of a wall member in the liquid crystal display panel of the second embodiment of the present invention.

FIG. 16 is a cross-sectional view illustrating a step of a liquid crystal display panel manufacturing method of the second embodiment of the present invention.

FIG. 17 is a cross-sectional view illustrating another step of the liquid crystal display panel manufacturing method of the second embodiment of the present invention.

FIG. 18 is a cross-sectional view illustrating still another step of the liquid crystal display panel manufacturing method of the second embodiment of the present invention.

FIG. 19 is a cross-sectional view illustrating still another step of the liquid crystal display panel manufacturing method of the second embodiment of the present invention.

FIG. 20 is a cross-sectional view illustrating still another step of the liquid crystal display panel manufacturing method of the second embodiment of the present invention.

FIG. 21 is a cross-sectional view illustrating still another step of the liquid crystal display panel manufacturing method of the second embodiment of the present invention.

FIG. 22 is a plan view illustrating an entire configuration of a variation of the liquid crystal display panel of the first embodiment of the present invention.

FIG. 23 is a cross-sectional view illustrating a configuration of a wall member in the liquid crystal display panel illustrated in FIG. 22.

FIG. 24 is a plan view illustrating an entire configuration of another variation of the liquid crystal display panel of the first embodiment of the present invention.

FIG. 25 is a cross-sectional view illustrating a configuration of a wall member in the liquid crystal display panel illustrated in FIG. 24.

### DETAILED DESCRIPTION OF THE INVENTION

Embodiments of the present invention will be described below in detail with reference to the drawings. Note that the present invention is not limited to the embodiments below.

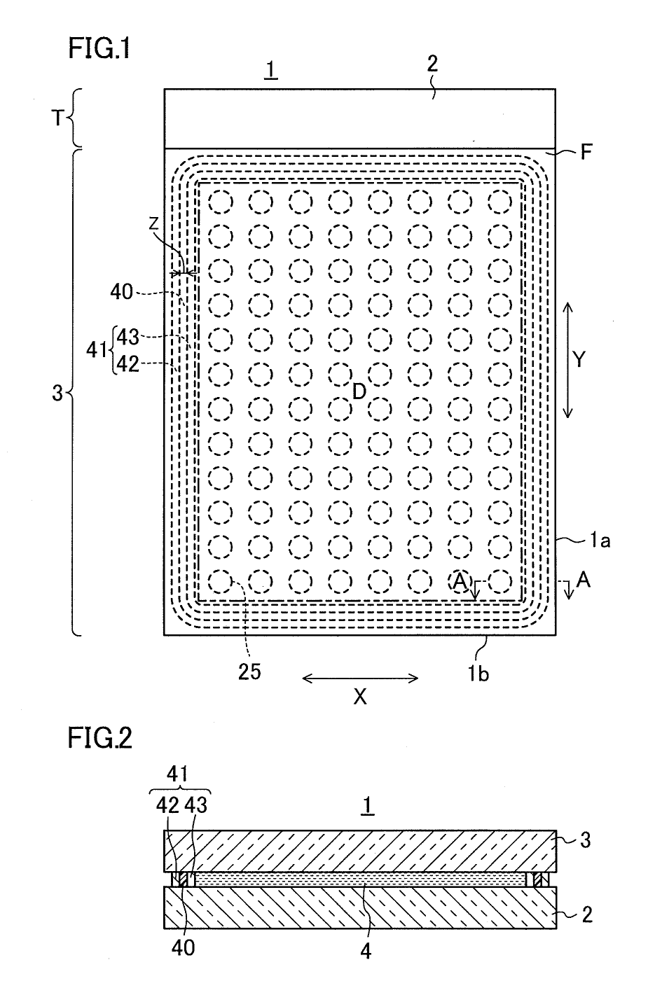

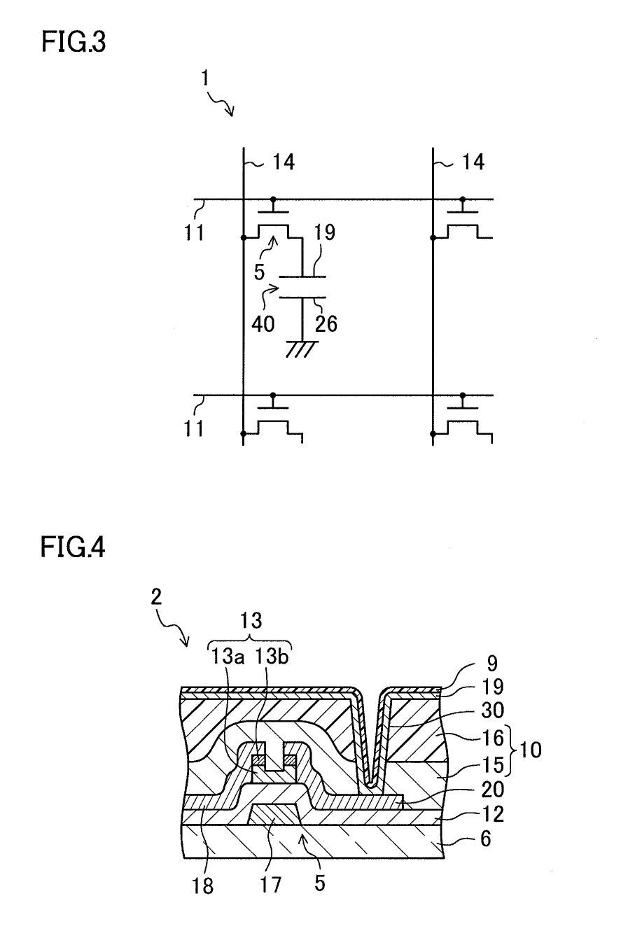

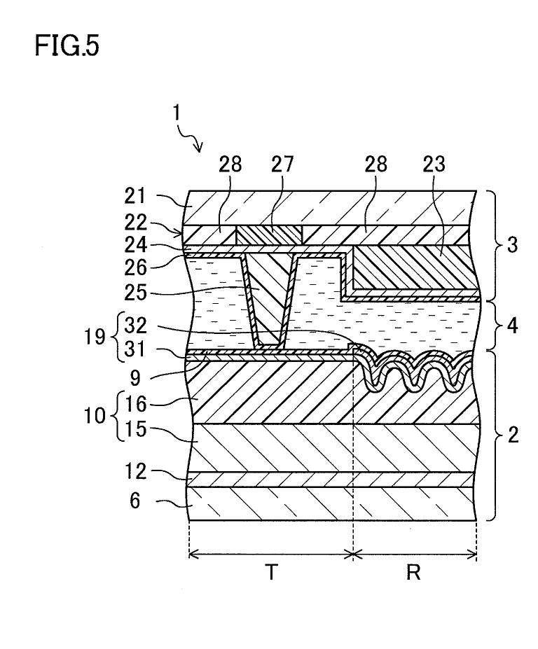

FIG. 1 is a plan view illustrating an entire configuration of a liquid crystal display panel of a first embodiment of the present invention, and FIG. 2 is a cross-sectional view of the liquid crystal display panel of the first embodiment of the present invention. In addition, FIG. 3 is an equivalent circuit diagram of the liquid crystal display panel of the first embodiment of the present invention, and FIG. 4 is a cross-sectional view illustrating an entire configuration of a TFT substrate forming the liquid crystal display panel of the first embodiment of the present invention. Further, FIG. 5 is a cross-sectional view illustrating an entire configuration of a display section of the liquid crystal display panel of the first embodiment of the present invention, and FIG. 6 is a cross-sectional view in a side direction of the liquid crystal display panel of the first embodiment of the invention, i.e., a cross-sectional view of FIG. 1 along an A-A line. Note that, in the present embodiment, a liquid crystal display panel will be described as an example of a display panel.

As illustrated in FIGS. 1 and 2, a liquid crystal display panel 1 includes a TFT substrate 2 which is a first substrate, a CF substrate 3 which is a second substrate arranged so as to face the TFT substrate 2, a liquid crystal layer 4 which is a display medium layer provided so as to be sandwiched between the TFT substrate 2 and the CF substrate 3, and a frame-shaped sealing material 40 for bonding the TFT substrate 2 and the CF substrate 3 together and sealing the liquid crystal layer 4, which is sandwiched between the TFT substrate 2 and the CF substrate 3.

The sealing material 40 is formed so as to surround the liquid crystal layer 4, and the TFT substrate 2 and the CF substrate 3 are bonded together with the sealing material 40 being interposed therebetween. The sealing material 40 is mixed with glass fibers 33 (see FIG. 6) made of, e.g., silica. As illustrated in FIG. 1, the liquid crystal display panel 1 further includes a plurality of photo spacers 25 for regulating the thickness of the liquid crystal layer 4 (i.e., a cell gap).

In addition, as illustrated in FIG. 1, the liquid crystal display panel 1 is formed in a rectangular shape. An upper side of the TFT substrate 2 protrudes beyond an upper side of the CF substrate 3 in a first side direction (longitudinal direction) Y which is a direction along a first side (i.e., a long side 1a) of the liquid crystal display panel 1. In a protruding region, a plurality of display wires such as gate lines and source lines are drawn out, and a terminal region T is formed.

In the liquid crystal display panel 1, a display region D where an image is displayed is defined in a region where the TFT substrate 2 and the CF substrate 3 are overlapped each other. The display region D is configured by arranging a plurality of pixels, each of which is the minimum unit of an image, in a matrix. In addition, a picture-frame region F where the sealing material 40 is provided is defined around the display region D.

Note that, as illustrated in FIG. 1, the sealing material 40 is provided in a rectangular frame-like shape so as to surround the entirety of the display region D. A frame width Z of the sealing material 40 is not limited, but may be set to, e.g., equal to or greater than 0.5 mm and equal to or less than 2.0 mm.

As illustrated in FIGS. 3 and 4, the TFT substrate 2 includes an insulating substrate 6 which is, e.g., a glass substrate, a plurality of gate lines 11 extending parallel to each other on the insulating substrate 6, and a gate insulating film 12 provided so as to cover the gate lines 11. The TFT substrate 2 further includes a plurality of source lines 14 extending parallel to each other in a direction perpendicular to the gate line 11 on the gate insulating film 12, and a plurality of TFTs 5 each provided in a portion where the gate line 11 and the source line 14 intersect one another. The TFT substrate 2 still further includes a first interlayer insulating film 15 and a second interlayer insulating film 16 provided in this order so as to cover the source lines 14 and the TFTs 5 and forming an interlayer insulating film 10, a plurality of pixel electrodes 19 provided in a matrix on the second interlayer insulating film 16 and connected to each of the TFTs 5, and an alignment film 9 provided so as to cover the pixel electrodes 19.

As illustrated in FIG. 4, the TFT 5 includes a gate electrode 17 from which the gate lines 11 laterally protrude, the gate insulating film 12 provided so as to cover the gate electrode 17, a semiconductor layer 13 provided in an island-like shape in a position coincidence with the gate electrode 17 on the gate insulating film 12, and a source electrode 18 and a drain electrode 20 provided so as to face each other on the semiconductor layer 13.

The source electrode 18 is a portion from which the source lines 14 laterally protrude. As illustrated in FIG. 4, the drain electrode 20 is connected to the pixel electrode 19 through a contact hole 30 formed in the first interlayer insulating film 15 and the second interlayer insulating film 16.

As illustrated in FIG. 5, the pixel electrode 19 includes a transparent electrode 31 provided on the second interlayer insulating film 16, and a reflecting electrode 32 stacked on the transparent electrode 31 and provided on a surface of the transparent electrode 31.

As illustrated in FIG. 4, the semiconductor layer 13 includes an intrinsic amorphous silicon layer 13a which is a lower layer, and an n⁺ amorphous silicon layer 13b doped with phosphorous, which is a layer above the intrinsic amorphous silicon layer 13a. Part of the intrinsic amorphous silicon layer 13a exposed through the source electrode 18 and the drain electrode 20 forms a channel region.

As illustrated in FIG. 5, in the TFT substrate 2 and a display section of the liquid crystal display panel 1 including the TFT substrate 2, a reflecting region R is defined by the reflecting electrode 32, and a transparent region T is defined by the transparent electrode 31 exposed through the reflecting electrode 32. In addition, as illustrated in FIG. 5, a surface of the second interlayer insulating film 16 below the pixel electrode 19 is formed in a corrugated shape, and a surface of the reflecting electrode 32 provided on the surface of the second interlayer insulating film 16 with the transparent electrode 31 being interposed therebetween is also formed in a corrugated shape.

Note that a material forming the first interlayer insulating film 15 is not limited, and examples of such a material include silicon oxide (SiO₂), silicon nitride (SiNx (x represents a positive number)), etc. The thickness of the first interlayer insulating film 15 is preferably equal to or greater than 600 nm and equal to or less than 1000 nm. This is because, if the thickness of the first interlayer insulating film 15 is less than 600 nm, a disadvantage may be caused, in which flattening of the first interlayer insulating film 15 is difficult, and, if the thickness of the first interlayer insulating film 15 is greater than 1000 nm, a disadvantage may be caused, in which it is difficult to form the contact hole 30 by etching.

As illustrated in FIG. 5, the CF substrate 3 includes an insulating substrate 21 which is, e.g., a glass substrate, a color filter layer 22 provided on the insulating substrate 21, and a transparent layer 23 for compensating an optical path difference between the reflecting region R and the transparent region T in the reflecting region R of the color filter layer 22. In addition, the CF substrate 3 further includes a common electrode 24 provided so as to cover the transparent region T of the color filter layer 22 and the transparent layer 23 (i.e., the reflecting region R), the photo spacer 25 provided in a column-like shape on the common electrode 24, and an alignment film 26 provided so as to cover the common electrode 24 and the photo spacer 25.

Note that the color filter layer 22 includes colored layers 28 which are red layers R, green layers G, and blue layers B provided for the pixels, and a black matrix 27 which is a light blocking layer. The black matrix 27 is provided so as to be interposed between adjacent ones of the colored layers 28, and functions to divide a plurality of colored layers 28. As illustrated in FIG. 5, the black matrix 27 is arranged so as to face the interlayer insulating film 10 which is a first member provided in the TFT substrate 2 with the photo spacer 25 being interposed between the black matrix 27 and the interlayer insulating film 10.

The photo spacer 25 illustrated in FIG. 1 is made of, e.g., acrylic photosensitive resin, and is formed by photolithography.

The black matrix 27 is made of, e.g., a metal material such as Ta (tantalum), Cr (chromium), Mo (molybdenum), Ni (nickel), Ti (titanium), Cu (copper), and Al (aluminum), a resin material in which black pigment such as carbon is dispersed, and a resin material in which colored layers having a plurality of colors and light transmitting properties are stacked.

The semi-transmissive liquid crystal display panel 1 having the foregoing configuration is configured so that light entering from a side closer to the CF substrate 3 is reflected on the reflecting electrode 32 in the reflecting region R, and transmission of light of a back light (not shown in the figure) entering from a side closer to the TFT substrate 2 is allowed in the transparent region T.

In the liquid crystal display panel 1, a single pixel is formed for each of the pixel electrodes 19. At each of the pixels, when a gate signal is sent through the gate line 11 to turn on the TFT 5, a source signal is sent through the source line 14, and predetermined electrical charge is written to the pixel electrode 19 through the source electrode 18 and the drain electrode 20. Then, a difference in potential is generated between the pixel electrode 19 and the common electrode 24, and predetermined voltage is applied to the liquid crystal layer 4. In the liquid crystal display panel 1, a change in alignment state of liquid crystal molecules depending on the magnitude of the applied voltage is used to adjust the transmittance of light to be emitted from the back light, thereby displaying an image.

As illustrated in FIGS. 1, 2, and 6, in the present embodiment, a wall member 41 formed adjacent to the sealing material 40 and sandwiching the sealing material 40 is provided in the picture-frame region F of the liquid crystal display panel 1.

As illustrated in FIG. 6, the wall member 41 includes a first wall member 42 formed adjacent to the sealing material 40 on an outer side relative to the sealing material 40 (i.e., on a side opposite to the liquid crystal layer 4 relative to the sealing material 40) in a second side direction (short-side direction) X of the liquid crystal display panel 1, and a second wall member 43 formed adjacent to the sealing material 40 on an inner side relative to the sealing material 40 (i.e., on a side closer to the liquid crystal layer 4 relative to the sealing material 40) in the second side direction X.

In addition, as illustrated in FIG. 6, the wall member 41 is formed in a step-like shape. Steps 42a, 43a are formed in the wall member 41 so that a width W₁ of a portion 40a of the sealing material 40, which contacts the TFT substrate 2 is larger on a side on which the sealing material 40 contacts the TFT substrate 2.

Thus, since the width W₁ of the portion 40a contacting the TFT substrate 2 is larger in the sealing material 40, an area where the sealing material 40 and the TFT substrate 2 contact each other can be increased. As a result, even if the width of the sealing material 40 to be provided in the picture-frame region F is reduced in order to realize narrowing of the picture-frame region, adhesion between the sealing material 40 and the TFT substrate 2 can be improved.

In addition, since a width W₂ of a portion 40b other than the port ion 40a contacting the TFT substrate 2 can be smaller in the sealing material 40, an amount of the sealing material 40 to be used is reduced, and the narrowing of the picture-frame region can be realized by a suitable amount of the sealing material 40.

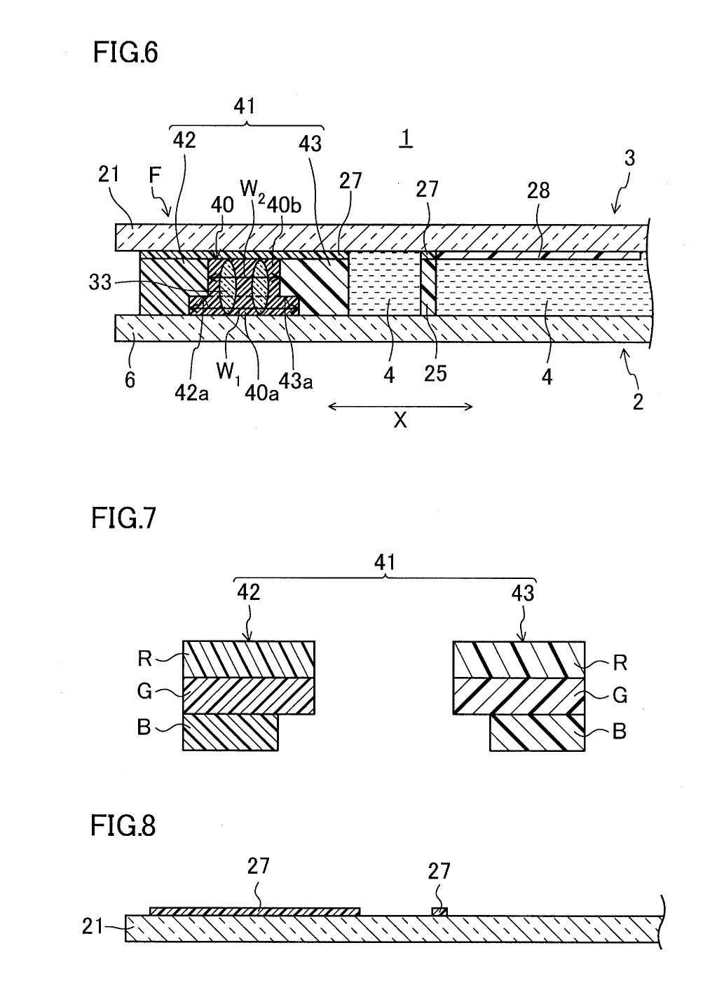

As illustrated in FIG. 7, in the present embodiment, an configuration is employed, in which the wall member 41 is formed by stacking the materials (e.g., acrylic photosensitive resin) forming the colored layers 28 (e.g., the red layer R, the green layer G, and the blue layer B) having three colors and forming the color filter layer 22. Thus, the wall member 41 can be made of an inexpensive general-purpose material without using other materials.

Next, one example of a liquid crystal display panel manufacturing method of the present embodiment will be described. FIGS. 8-13 are cross-sectional views illustrating steps of the liquid crystal display panel manufacturing method of the first embodiment of the present invention. Note that, the manufacturing method of the present embodiment includes fabrication of a TFT substrate, and fabrication of a CF substrate, and bonding of the substrates.

First, e.g., a titanium film, an aluminum film, and a titanium film are formed in this order on the entirety of an insulating substrate 6 by sputtering, and then patterning is performed by photolithography. In such a manner, gate lines 11 and gate electrodes 17 are formed so as to have a thickness of about 4000 Å.

Subsequently, e.g., a silicon nitride film is formed on the entire substrate on which the gate lines 11 and the gate electrodes 17 are formed, by plasma chemical vapor deposition (CVD), and a gate insulating film 12 is formed so as to have a thickness of about 4000 Å.

Then, e.g., an intrinsic amorphous silicon film (a thickness of about 2000 Å) and an n⁺ amorphous silicon film (a thickness of about 500 Å) doped with phosphorous are successively formed on the entire substrate on which the gate insulating film 12 is formed, by the plasma CVD. Subsequently, such films are patterned into an island-like shape on the gate electrodes 17 by the photolithography, thereby forming a semiconductor formation layer in which an intrinsic amorphous silicon layer and an n⁺ amorphous silicon layer are stacked.

Then, e.g., an aluminum film and a titanium film are formed in this order on the entire substrate on which the semiconductor formation layer is formed, by the sputtering, and then patterning is performed by the photolithography. In such a manner, source lines 14, source electrodes 18, and drain electrodes 20 are formed so as to have a thickness of about 2000 Å.

Subsequently, the n⁺ amorphous silicon layer of the semiconductor formation layer is etched by using the source electrodes 18 and the drain electrodes 20 as a mask, and is patterned into channel regions. In such a manner, a semiconductor layer 13 and TFTs 5 including the semiconductor layer 13 are formed.

Then, e.g., a silicon nitride film is formed on the entire substrate on which the TFTs 5 are formed, by the plasma CVD, and then a first interlayer insulating film 15 is formed so as to have a thickness of about 4000 Å.

Then, e.g., positive photosensitive resin is applied to the entire substrate on which the first interlayer insulating film 15 is formed, so as to have a thickness of about 3 μm by spin coating. The applied photosensitive resin is uniformly exposed to light at relatively-low luminance through a first photo mask in which a plurality of circular light blocking sections are randomly formed so as to be apart from each other. Subsequently, after such resin is uniformly exposed to light at relatively-high luminance through a second photo mask in which an opening is formed in a position corresponding to a contact hole 30 on each of the drain electrodes 20, the resin is developed.

This allows complete removal of part of the photosensitive resin, which is exposed to light at the high luminance. Part of the photosensitive resin, which is exposed to light at the low luminance remains with about 40% of the thickness of the applied photosensitive resin. Part of the photosensitive resin, which is not exposed to light remains with about 80% of the thickness of the applied photosensitive resin. Further, the substrate with the developed photosensitive resin is heated to about 200° C. to melt the photosensitive resin, thereby forming a second interlayer insulating film 16 having a smooth and corrugated surface in each of reflecting regions R. Subsequently, the first interlayer insulating film 15 exposed through the second interlayer insulating film 16 is etched, thereby forming the contact holes 30.

Subsequently, a transparent conductive film including, e.g., an ITO film is formed on the entire substrate on which the second interlayer insulating film 16 is formed, by the sputtering, and then patterning is performed by the photolithography. In such a manner, transparent electrodes 31 are formed so as to have a thickness of about 1000 Å on the insulating substrate 6.

Subsequently, a molybdenum film (a thickness of about 750 Å) and an aluminum film (a thickness of about 1000 Å) are formed in this order on the entire substrate on which the transparent electrodes 31 are formed, by the sputtering, and then patterning is performed by the photolithography. In such a manner, in each of the reflecting regions R, a reflecting electrode 32 is formed on a surface of the transparent electrode 31, thereby forming a pixel electrode 19 including the transparent electrode 31 and the reflecting electrode 32.

Subsequently, polyimide resin is applied to the entire substrate on which the pixel electrodes 19 are formed, by printing, and then rubbing is performed. In such a manner, an alignment film 9 is formed so as to have a thickness of about 1000 Å.

In the foregoing manner, a TFT substrate 2 can be fabricated.

First, e.g., positive photosensitive resin in which black pigment such as carbon particulates are dispersed is applied to the entirety of an insulating substrate 21 such as a glass substrate by spin coating. The applied photosensitive resin is exposed to light through a photomask, and then is developed and heated. In such a manner, as illustrated in FIG. 8, a black matrix 27 is formed so as to have a thickness of about 2.0 μm on the insulating substrate 21.

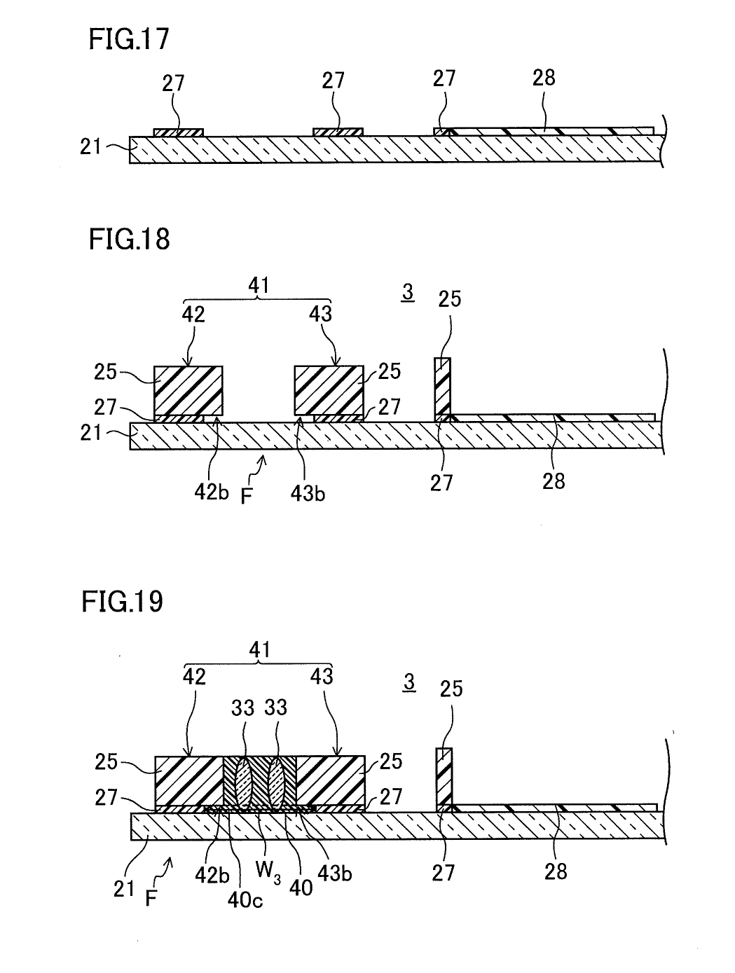

Subsequently, e.g., acrylic photosensitive resin colored red, green, or blue is applied to the substrate on which the black matrix 27 is formed. The applied photosensitive resin is exposed to light through a photomask, and then patterning is performed by developing the photosensitive resin. In such a manner, as illustrated in FIG. 17, a colored layer (e.g., a red-colored layer R) 28 having a selected color is formed so as to have a thickness of about 2.0 μm. Further, the similar step is repeated for the remaining two colors, thereby forming colored layers (e.g., a green-colored layer G and a blue-colored layer B) 28 having the remaining two colors so as to have a thickness of about 2.0 μm. As a result, a color filter layer 22 including the red-colored layer R, the green-colored layer G, and the blue-colored layer B is formed.

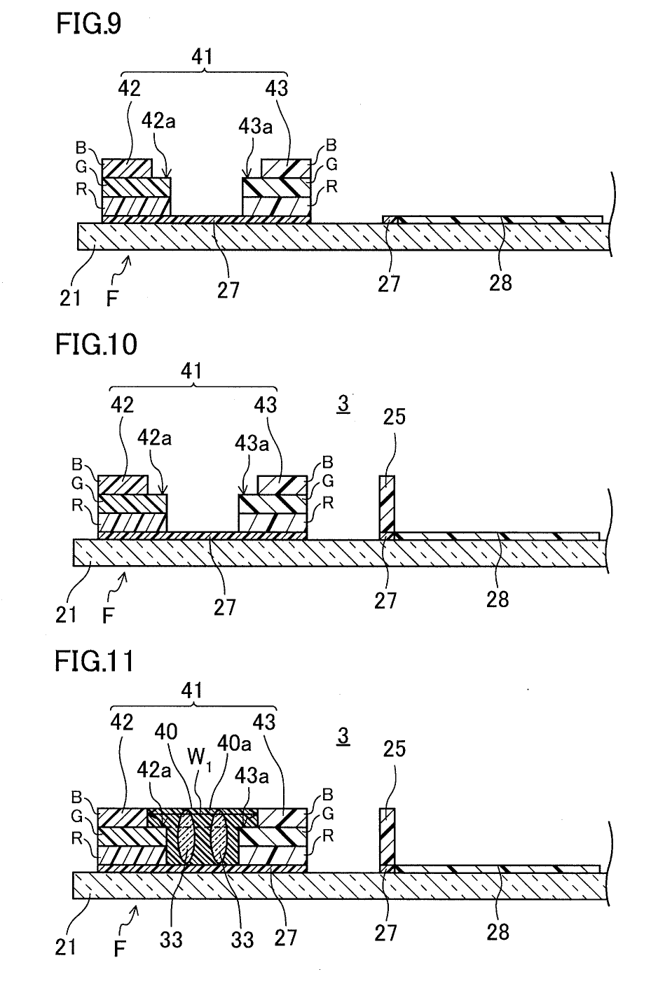

In the foregoing state, as illustrated in FIG. 9, acrylic photosensitive resins colored red, green, and blue are applied and stacked in this order on the black matrix 27 in a picture-frame region F. The applied photosensitive resins are exposed to light through a photomask, and patterning is performed by developing the photosensitive resins. In such a manner, a wall member 41 having steps 42a, 43a is formed.

As described above, in the present embodiment, since the color filter layer 22 and the wall member 41 can be simultaneously formed, the wall member 41 can be formed without increasing the number of process steps.

Subsequently, acrylic photosensitive resin is applied to the substrate on which the color filter layer 22 is formed, by the spin coating. The applied photosensitive resin is exposed to light through a photomask, and then is developed. In such a manner, a transparent layer 23 is formed so as to have a thickness of about 2 μm.

Subsequently, e.g., an ITO film is formed on the entire substrate on which the transparent layer 23 is formed, by sputtering, and then patterning is performed by photolithography. In such a manner, a common electrode 24 is formed so as to have a thickness of about 1500 Å.

Subsequently, acrylic photosensitive resin is applied to the entire substrate on which the common electrode 24 is formed, by the spin coating. The applied photosensitive resin is exposed to light through a photomask, and then is developed. In such a manner, as illustrated in FIG. 10, photo spacers 25 are formed so as to have a thickness of about 4 μm. Then, polyimide resin is applied to the entire substrate on which the photo spacers 25 are formed, by printing, and then rubbing is performed. In such a manner, an alignment film 26 is formed so as to have a thickness of about 1000 Å.

In the foregoing manner, a CF substrate 3 can be fabricated.

First, e.g., a dispenser is used to apply, in a frame-like shape, a sealing material 40 made of, e.g., ultraviolet-thermal curable resin mixed with glass fibers 33 to the CF substrate 3 fabricated in the fabrication of the CF substrate.

In the foregoing state, as illustrated in FIG. 11, the sealing material 40 is applied between the first wall member 42 and the second wall member 43 forming the wall member 41 in the picture-frame region F. In addition, as illustrated in FIG. 11, the sealing material 40 is applied so that, when the TFT substrate 2 and the CF substrate 3 are bonded together, a width W₁ of a portion 40a contacting the TFT substrate 2 is larger in the sealing material 40.

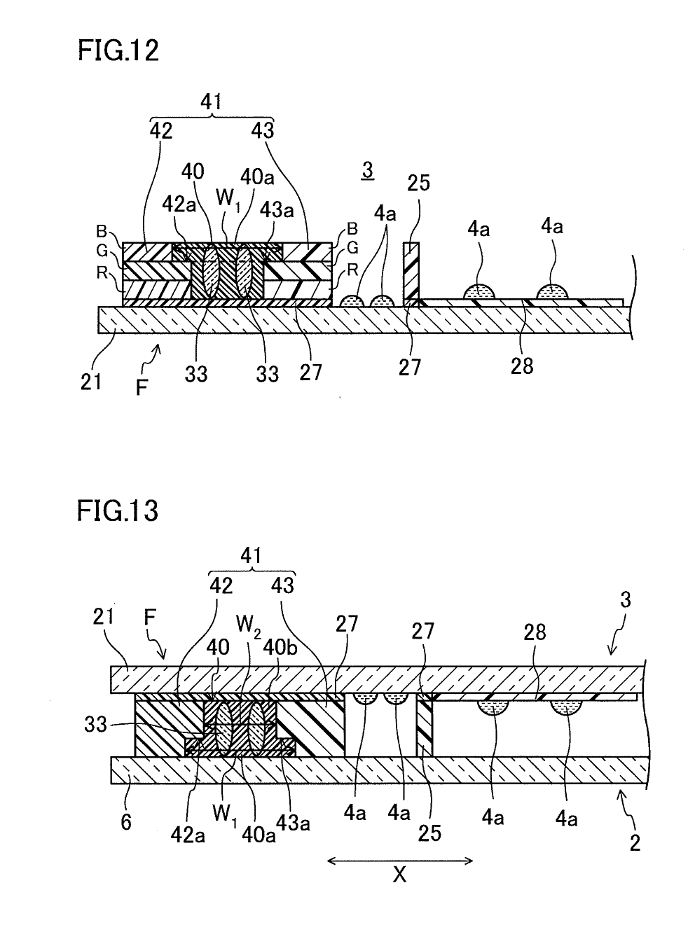

Subsequently, as illustrated in FIG. 12, a liquid crystal material 4a is dropped to a region on an inner side relative to the sealing material 40 on the CF substrate 3 to which the sealing material 40 is applied.

Subsequently, as illustrated in FIG. 13, after the CF substrate 3 to which the liquid crystal material 4a is dropped and the TFT substrate 2 fabricated in the fabrication of the TFT substrate are bonded together under reduced pressure, the bonded body is exposed to atmosphere pressure, thereby applying pressure on front and back surfaces of the bonded body.

Then, after the sealing material 40 sandwiched between the substrates of the bonded body is irradiated with UV light, the sealing material 40 is cured by heating the bonded body.

In the foregoing state, since the width W₁ of the portion 40a contacting the TFT substrate 2 is larger in the sealing material 40, an area where the sealing material 40 and the TFT substrate 2 contact each other is increased.

In the foregoing manner, a liquid crystal display panel 1 illustrated in FIG. 6 can be fabricated.

According to the present embodiment described above, the following advantages can be realized.

(1) In the present embodiment, the wall member 41 formed adjacent to the sealing material 40 and sandwiching the sealing material 40 is provided in the picture-frame region F. In addition, the steps 42a, 43a are formed in the wall member 41 so that the width W₁ of the portion 40a of the sealing material 40, which contacts the TFT substrate 2 is larger on the side on which the sealing material 40 contacts the TFT substrate 2. Thus, since the width W₁ of the portion 40a contacting the TFT substrate 2 is larger in the sealing material 40, the area where the sealing material 40 and the TFT substrate 2 contact each other can be increased. As a result, even if the width of the sealing material 40 to be provided in the picture-frame region F is reduced in order to realize the narrowing of the picture-frame region, the adhesion between the sealing material 40 and the TFT substrate 2 can be improved, thereby preventing a disadvantage that the sealing material 40 is peeled off.

(2) Since the width W₂ of the portion 40b other than the portion 40a contacting the TFT substrate 2 is smaller in the sealing material 40, the amount of the sealing material 40 to be used can be reduced. Thus, an increase in cost can be reduced while realizing the narrowing of the picture-frame region by the suitable amount of the sealing material 40.

(3) In the present embodiment, the wall member 41 is made of the material forming the colored layers 28 (the red-colored layer R, the green-colored layer G, and the blue-colored layer B) having the three colors and forming the color filter layer 22. Thus, the wall member 41 can be made of the inexpensive general-purpose material without using other materials.

(4) In the present embodiment, the sealing material 40 is mixed with the glass fibers 33. Thus, the glass fibers 33 allow a weight on the sealing material 40 in the first side direction Y of the liquid crystal display panel 1 and a weight on the sealing material 40 in the second side direction X of the liquid crystal display panel 1 to be more precisely equal to each other. Thus, since holding of the TFT substrate 2 and the CF substrate 3 with a predetermined clearance can be ensured, setting of the thickness of the liquid crystal layer 4 in the first side direction Y of the liquid crystal display panel 1 and the thickness of the liquid crystal layer 4 in the second side direction X of the liquid crystal display panel 1 to the same value can be ensured. As a result, a more uniform thickness of the liquid crystal layer 4 can be maintained.

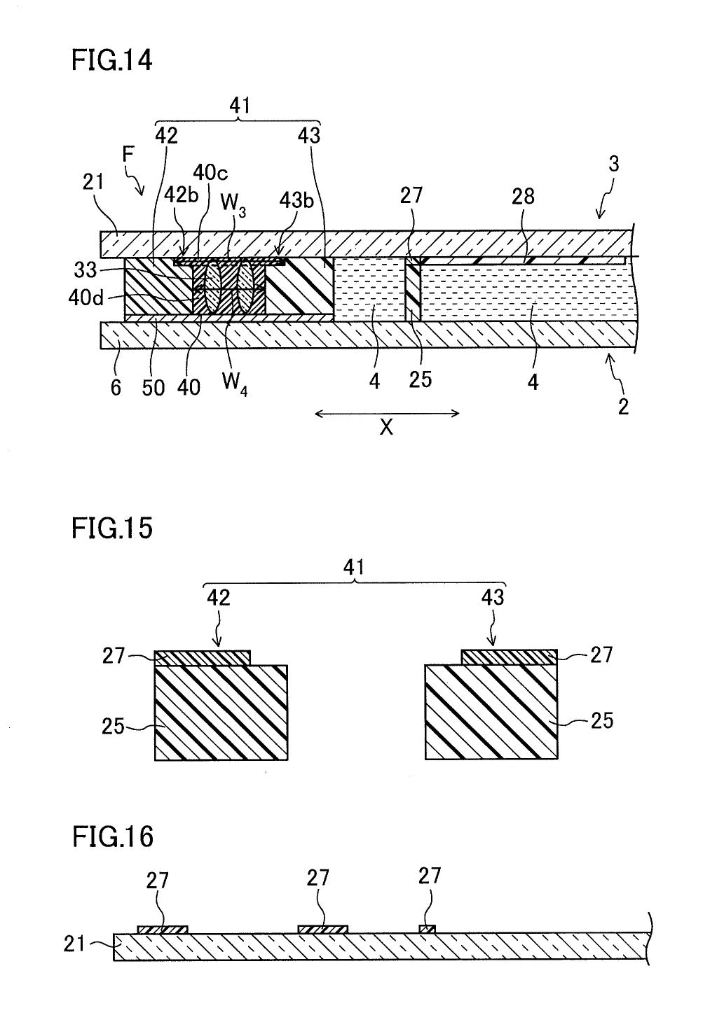

Next, a second embodiment of the present invention will be described. FIG. 14 is a cross-sectional view of a liquid crystal display panel of the second embodiment of the present invention in a side direction thereof, and corresponds to FIG. 6. Note that the same reference numerals as those shown in the first embodiment are used to represent equivalent elements, and the description thereof will not be repeated. In addition, since an entire configuration of the liquid crystal display panel and an entire configuration of a TFT substrate are similar to those described in the first embodiment, the detailed description thereof will not be repeated. Further, in the present embodiment, the liquid crystal display panel will be also described as an example of a display panel.

In the present embodiment, as illustrated in FIGS. 14 and 15, a wall member 41 is formed by stacking a material forming a black matrix 27 and a material forming a photo spacer 25. Thus, as in the first embodiment, the wall member 41 can be made of an inexpensive general-purpose material without using other materials.

In the present embodiment, as illustrated in FIG. 14, the wall member 41 is formed in a step-like shape, and steps 42b, 43b are formed in the wall member 41 on a side on which a sealing material 40 contacts a CF substrate 3.

Thus, since a width W₃ of a portion 40c contacting the CF substrate 3 is larger in the sealing material 40, an area where the sealing material 40 and the CF substrate 3 contact each other is increased. Consequently, even if the width of the sealing material 40 to be provided in a picture-frame region F is reduced in order to realize narrowing of the picture-frame region, adhesion between the sealing material 40 and the CF substrate 3 can be improved.

In addition, since a width W₄ of a portion 40d other than the port ion 40c contacting the CF substrate 3 is smaller in the sealing material 40, an amount of the sealing material 40 to be used is reduced, and the narrowing of the picture-frame region can be realized by a suitable amount of the sealing material 40.

Note that, in FIG. 14, a wire layer pattern 50 formed on a TFT substrate 2 by a plurality of display wires such as gate lines and source lines is illustrated in the picture-frame region F. In the present embodiment, the sealing material 40 contacts the wire layer 50 on a side closer to the TFT substrate 2.

Next, one example of a liquid crystal display panel manufacturing method of the present embodiment will be described. FIGS. 16-21 are cross-sectional views illustrating steps of the liquid crystal display panel manufacturing method of the second embodiment of the present invention. Note that, as in the first embodiment, the manufacturing method of the present embodiment includes fabrication of a TFT substrate, fabrication of a CF substrate, and bonding of the substrates.

First, a TFT substrate 2 is fabricated as in the the first embodiment.

Next, as in the first embodiment, a black matrix 27 is formed so as to have a thickness of about 2.0 μm on an insulating substrate 21 as illustrated in FIG. 16.

Subsequently, e.g., acrylic photosensitive resin colored red, green, or blue is applied to the substrate on which the black matrix 27 is formed. The applied photosensitive resin is exposed to light through a photomask, and then patterning is performed by developing the photosensitive resin. In such a manner, a colored layer (e.g., a red-colored layer) 28 having a selected color is formed so as to have a thickness of about 2.0 μm. Further, the similar step is repeated for the remaining two colors, thereby forming colored layers (e.g., a green-colored layer G and a blue-colored layer B) 28 having the remaining two colors so as to have a thickness of about 2.0 μm. As a result, as illustrated in FIG. 17, a color filter layer 22 including the red-colored layer R, the green-colored layer G, and the blue-colored layer B is formed.

Subsequently, as in the first embodiment, a transparent layer 23 is formed on the substrate on which the color filter layer 22 is formed, and a common electrode 24 is formed on the entire substrate on which the transparent layer 23 is formed.

Subsequently, acrylic photosensitive resin is applied to the entire substrate on which the common electrode 24 is formed, by spin coating. The applied photosensitive resin is exposed to light through a photomask, and then is developed. In such a manner, as illustrated in FIG. 18, photo spacers 25 are formed so as to have a thickness of about 4 μm.

In the foregoing state, as illustrated in FIG. 18, acrylic photosensitive resin is applied to the black matrix 27 in a picture-frame region F. The applied photosensitive resin is exposed to light through a photomask, and then patterning is performed by developing the photosensitive resin. In such a manner, a wall member 41 is formed, which is formed by the black matrix 27 and the photo spacers 25 and includes steps 42b, 43b.

As described above, in the present embodiment, since the black matrix 27, the photo spacers 25, and the wall member 41 can be simultaneously formed, the wall member 41 can be formed without increasing the number of process steps.

Then, polyimide resin is applied to the entire substrate on which the photo spacers 25 are formed, by printing, and then rubbing is performed. In such a manner, an alignment film 26 is formed so as to have a thickness of about 1000 Å.

In the foregoing manner, a CF substrate 3 can be fabricated.

Subsequently, e.g., a dispenser is used to apply, in a frame-like shape, a sealing material 40 made of, e.g., ultraviolet-thermal curable resin mixed with glass fibers 33 to the fabricated CF substrate 3. In such a state, as illustrated in FIG. 19, the sealing material 40 is applied between a first wall member 42 and a second wall member 43 forming the wall member 41 in the picture-frame region F. In addition, as illustrated in FIG. 19, the sealing material 40 is applied so that, when the TFT substrate 2 and the CF substrate 3 are bonded together, a width W₃ of a portion 40c contacting the CF substrate 3 is larger in the sealing material 40.

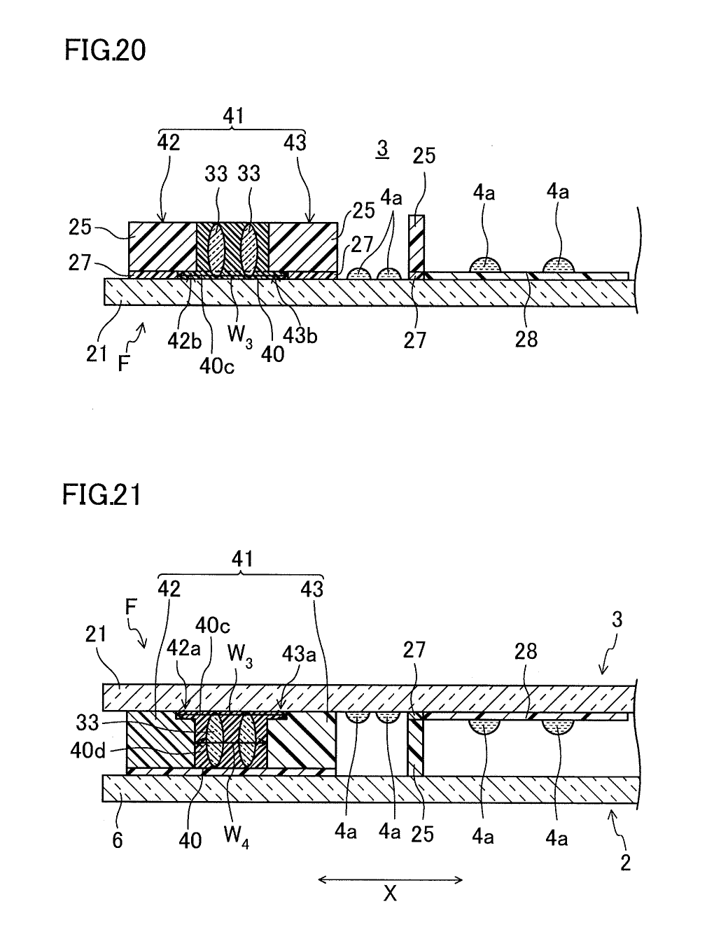

Subsequently, as in the first embodiment, a liquid crystal material 4a is dropped to a region on an inner side relative to the sealing material 40 on the CF substrate 3 to which the sealing material 40 is applied as illustrated in FIG. 20.

Subsequently, as illustrated in FIG. 21, after the CF substrate 3 to which the liquid crystal material 4a is dropped and the TFT substrate 2 fabricated in the fabrication of the TFT substrate are bonded together under reduced pressure, the bonded body is exposed to atmosphere pressure, thereby applying pressure on front and back surfaces of the bonded body.

Then, after the sealing material 40 sandwiched between the substrates of the bonded body is irradiated with UV light, the sealing material 40 is cured by heating the bonded body.

In such a state, since the width W₃ of the portion 40c contacting the CF substrate 3 is larger in the sealing material 40, an area where the sealing material 40 and the TFT substrate 2 contact each other is increased.

In the foregoing manner, a liquid crystal display panel 1 illustrated in FIG. 14 can be fabricated.

According to the present embodiment described above, the following advantages can be realized in addition to advantage (4).

(5) In the present embodiment, the wall member 41 formed adjacent to the sealing material 40 and sandwiching the sealing material 40 is provided in the picture-frame region F. In addition, the steps 42b, 43b are formed in the wall member 41 so that the width W₃ of the portion 40c of the sealing material 40, which contacts the CF substrate 3 is larger on a side on which the sealing material 40 contacts the TFT substrate 2. Thus, since the width W₃ of the portion 40c contacting the CF substrate 3 is larger in the sealing material 40, an area where the sealing material 40 and the CF substrate 3 contact each other can be increased. As a result, even if the width of the sealing material 40 to be provided in the picture-frame region F is reduced in order to realize narrowing of the picture-frame region, adhesion between the sealing material 40 and the CF substrate 3 can be improved, thereby preventing a disadvantage that the sealing material 40 is peeled off.

(6) Since a width W₄ of a portion 40d other than the portion 40c contacting the CF substrate 3 is smaller in the sealing material 40, an amount of the sealing material 40 to be used can be reduced. Thus, an increase in cost can be reduced while realizing the narrowing of the picture-frame region by a suitable amount of the sealing material 40.

(7) In the present embodiment, the wall member 41 is formed by stacking a material forming the black matrix 27 and a material forming the photo spacer 25. Thus, the wall member 41 can be made of an inexpensive general-purpose material without using other materials.

Note that the foregoing embodiments may be changed as follows.

In the foregoing embodiments, the wall member 41 is formed by stacking the materials forming the colored layers (the red-colored layer R, the green-colored layer G, and the blue-colored layer B) 28 having the three colors and forming the color filter layer 22, or by stacking the material forming the black matrix 27 and the material forming the photo spacer 25. However, the wall member 41 may be made of a material forming at least one selected from a group consisting of the colored layer 28, the black matrix 27, the photo spacer 25, and a rib 45 which will be described later. According to such a configuration, the wall member 41 can be made of the inexpensive general-purpose material which is already used for the CF substrate 3 without using other materials.

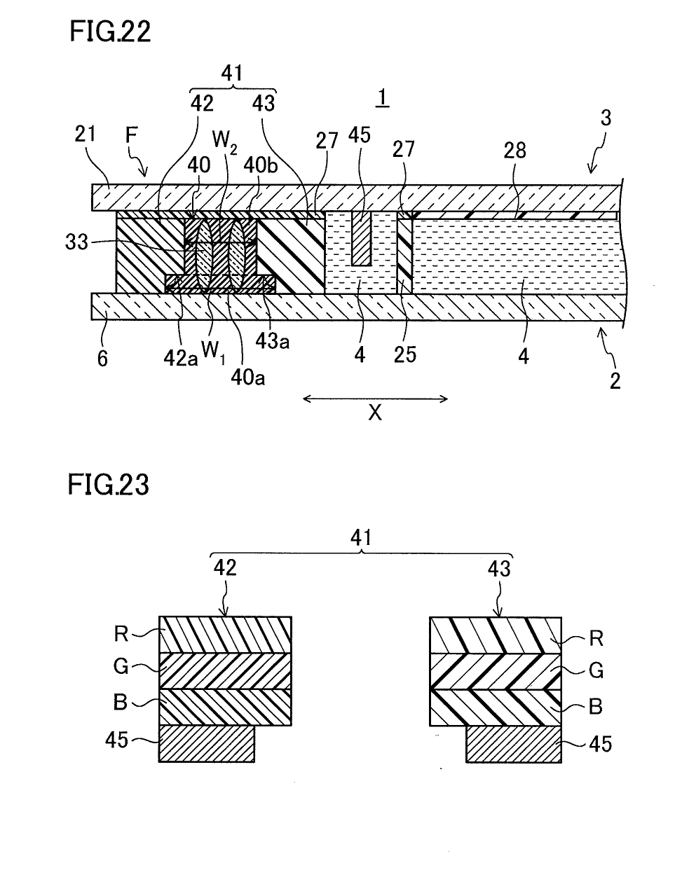

As illustrated in, e.g., FIGS. 22 and 23, the wall member 41 may be formed by stacking the materials forming the colored layers (e.g., the red-colored layer R, the green-colored layer G, and the blue-colored layer B) 28 having the three colors and forming the color filter layer 22 and a material (e.g., acrylic photosensitive resin) forming the rib 45. In such a configuration, advantages similar to advantages (1)-(4) described in the first embodiment can be also realized.

Note that, as illustrated in FIG. 22, the rib 45 protrudes from a surface of the CF substrate 3 toward a surface of the TFT substrate 2 in the liquid crystal layer 4, and has a raised shape in a cross section. The rib 45 is formed in a direction perpendicular to a gravity acting direction when the liquid crystal display panel 1 is in an upright position. The rib 45 allows acting of transfer resistance when liquid crystal moves in the clearance, and, as a result, it is less likely to cause the non-uniform gravity.

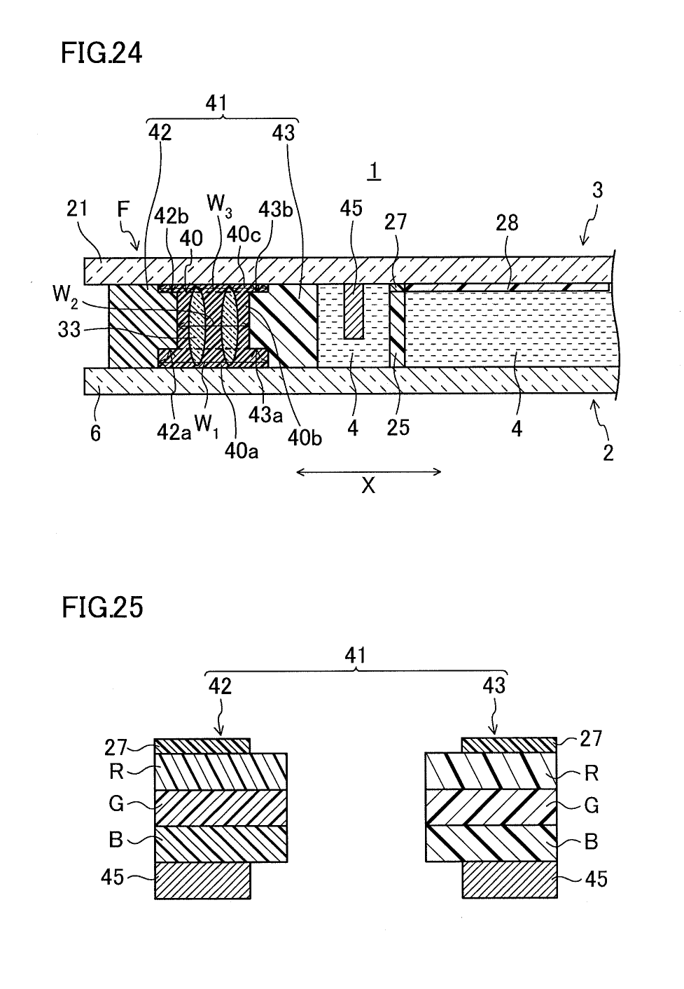

As illustrated in, e.g., FIGS. 24 and 25, the wall member 41 may be formed by stacking the material forming the black matrix 27, the materials forming the colored layers (e.g., the red-colored layer R, the green-colored layer G, and the blue-colored layer B) 28 having the three colors and forming the color filter layer 22, and the material forming the rib 45.

In such a case, as illustrated in FIG. 24, the wall member 41 is formed in a step-like shape. In the wall member 41, the steps 42a, 43a are formed on the side on which the sealing material 40 contacts the TFT substrate 2, and the steps 42b, 43b are formed on the side on which the sealing material 40 contacts the CF substrate 3. In such a configuration, advantages similar to advantages (1)-(7) described in the first and second embodiments can be also realized.

That is, since the width W₁ of the portion 40a contacting the TFT substrate 2 is larger in the sealing material 40, the area where the sealing material 40 and the TFT substrate 2 contact each other can be increased. In addition, since the width W₃ of the portion 40c contacting the CF substrate 3 is larger in the sealing material 40, the area where the sealing material 40 and the CF substrate 3 contact each other can be increased.

Thus, even if the width of the sealing material 40 to be provided in the picture-frame region F is reduced in order to realize the narrowing of the picture-frame region, adhesion between the sealing material 40 and the TFT substrate 2 is improved while improving the adhesion between the sealing material 40 the CF substrate 3. Consequently, the disadvantage that the sealing material 40 is peeled off can be more effectively prevented.

Since the width W₂ of the portion 40b other than the portion 40a contacting the TFT substrate 2 and the portion 40c contacting the CF substrate 3 is smaller in the sealing material 40, the narrowing of the picture-frame region can be realized by a more suitable amount of the sealing material 40.

As described above, the present invention may be configured so that the steps 42a, 42b, 43a, 43b are formed in the wall member 41 so that the widths W₁, W₃ of the portions 40a, 40c of the sealing material 40, which contact the TFT substrate 2 and the CF substrate 3, respectively are larger on the sides on which the sealing material 40 contacts the TFT substrate 2 and the CF substrate 3.

That is, the present invention may be configured so that the step is formed in the wall member 41 so that the width of the portion of the sealing material 40, which contacts at least one of the TFT substrate 2 or the CF substrate 3 is larger on the side where the sealing material 40 contacts at least one of the TFT substrate 2 or the CF substrate 3.

In the foregoing embodiments, the liquid crystal display panel 1 has been described as the example of the display panel. However, the present invention can be applied to other display panels such as organic EL display panels.

As described above, the present invention is suitable for the display panel such as the liquid crystal display panel in which the pair of substrates are stacked with the predetermined clearance and liquid crystal is sealed in the clearance between the pair of substrates.

### DESCRIPTION OF REFERENCE CHARACTERS

1 Liquid Crystal Display Panel
2 TFT Substrate (First Substrate)
3 CF Substrate (Second Substrate)
4 Liquid Crystal Layer (Display Medium Layer)
5 TFT
13 Semiconductor Layer
17 Gate Electrode
25 Spacer
27 Black Matrix
28 Colored Layer
33 Glass Fiber
40 Sealing Material
40a Portion of Sealing Material, which Contacts TFT Substrate
40c Portion of Sealing Material, which Contacts CF Substrate
41 Wall Member
42a Step
42b Step
43a Step
43b Step
45 Rib
B Blue-Colored Layer
D Display Region
F Picture-Frame region
G Green-Colored Layer
R Red-Colored Layer
W₁ Width of Portion of Sealing Material, which Contacts TFT Substrate
W₃ Width of Portion of Sealing Material, which Contacts CF Substrate

1. A display panel, comprising:
a first substrate;
a second substrate arranged so as to face the first substrate;
a display medium layer provided between the first and second substrates; and
a sealing material for bonding the first and second substrates together, which is provided in a picture-frame region defined around a display region where an image is displayed and is sandwiched between the first and second substrates,
wherein a wall member formed adjacent to the sealing material and sandwiching the sealing material is provided in the picture-frame region, and a step is formed in the wall member so that a width of a portion of the sealing material, which contacts at least one of the first or second substrate is larger on a side on which the sealing material contacts the at least one of the first or second substrate.

2. The display panel of claim 1, wherein
the second substrate includes a colored layer, a black matrix, and a spacer for regulating a thickness of the display medium layer on a liquid crystal layer side and further includes a rib protruding from the second substrate toward the first substrate in the liquid crystal layer, and the wall member is made of a material forming at least one selected from a group consisting of the colored layer, the black matrix, the spacer, and the rib.

3. The display panel of claim 1, wherein
the second substrate includes a colored layer on a liquid crystal layer side, and the wall member is made of a material forming the colored layer.

4. The display panel of claim 3, wherein
the second substrate further includes a rib protruding from the second substrate toward the first substrate in the liquid crystal layer, and the wall member is formed by stacking the material forming the colored layer and a material forming the rib.

5. The display panel of claim 4, wherein
the second substrate further includes a black matrix on the liquid crystal layer side, and the wall member is formed by stacking the material forming the colored layer, the material forming the rib, and a material forming the black matrix.

6. The display panel of claim 1, wherein
the second substrate includes a black matrix and a spacer for regulating a thickness of the display medium layer on a liquid crystal layer side, and the wall member is formed by stacking a material forming the black matrix and a material forming the spacer.

7. The display panel according to claim 1, wherein
the sealing material is mixed with glass fibers.

8. The display panel according to claim 1, wherein
the display medium layer is a liquid crystal layer.
